(19) United States
(12) Patent Application Publication
(10) Pub. No.: US 2026/0100587 A1
(43) Pub. Date: Apr. 9, 2026

(54) SYSTEMS AND METHODS FOR A MOBILE GRID AND INDUSTRIAL POWER DELIVERY

(71) Applicant: Critical Loop, Inc., Long Beach, CA (US)

(72) Inventors: Charles Leigh, Long Beach, CA (US); Dante Sblendorio, Long Beach, CA (US); Lydia Maher, Long Beach, CA (US); Balachandar Ramamurthy, Long Beach, CA (US); Andrew Grinalds, Long Beach, CA (US)

(73) Assignee: Critical Loop, Inc., Long Beach, CA (US)

(21) Appl. No.: 19/348,071

(22) Filed: Oct. 2, 2025

Related U.S. Application Data
(60) Provisional application No. 63/703,860, filed on Oct. 4, 2024.

(51) Int. Cl. H02J 3/40; H02J 3/00; H02J 3/32; H02J 3/38; H02J 3/46; H02J 13/00

(52) U.S. Cl. CPC H02J 3/40; H02J 3/003; H02J 3/007; H02J 3/32; H02J 3/388; H02J 3/466; H02J 13/12; H02J 13/34; H02J 2101/24

(57) ABSTRACT

Systems and methods for industrial power delivery can include an electrical combiner system. The system can include a housing, a first breaker, a second breaker, and a network device. The first breaker is in communication with a first power source and comprises a first programmable controller. The second breaker is in communication with a second power source and comprises a second programmable controller. A site controller is in electronic communication with the first breaker and the second breaker, and is configured to synchronize a voltage of the first power source and a voltage of the second power source.

### CROSS REFERENCE TO RELATED APPLICATIONS

This application claims priority to, and the benefit of, U.S. Provisional Patent Application Ser. No. 63/703,860, entitled “SYSTEMS AND METHODS FOR A MOBILE GRID AND INDUSTRIAL POWER DELIVERY,” filed on Oct. 4, 2024. The '860 Application is hereby incorporated by reference in its entirety for all purposes.

### FIELD OF INVENTION

The present disclosure relates generally to electrical power systems and methods, such as electrical power storage, electrical power management, and electrical power generation, particularly to improved systems and methods of mobile electrical energy storage and grid management.

### BACKGROUND

The subject matter discussed in the background section should not be assumed to be prior art merely as a result of its mention in the background section. Similarly, a problem mentioned in the background section or associated with the subject matter of the background section should not be assumed to have been previously recognized in the prior art. The subject matter in the background section merely represents different approaches, which in and of themselves may be inventions.

Over the years energy prices have continued to increase at the public utility level. Further, reliability of the current power grid infrastructure is lacking due to higher consumer demand, increased load on the power grid, and the cost of upgrading grid infrastructure, which has kept the grid from improving and updating with modern technology. Further, alternative forms of power generation (i.e., solar and wind power) are not efficiently connected to the grid due to the intermittency of power generation inherent with said modalities. Solar power can only be generated during the day and wind can only be generated when there is enough wind to drive turbines. When those forms of power generation are active, the power generated is not completely captured as the power generated often exceeds demand during those times. Therefore, static power storage devices are implemented to collect some of the overage power generated by alternative generation methods.

Static power storage devices, however, tend to be collocated with energy production and are subject to transmission congestion issues that result in an inability to take advantage of this power. Current solutions, such as building storage is limited by an interconnect queue which is often backed up, and aggregated battery storage, such as conglomeration of car batteries, are not long-term solutions.

Further, utility revenue is often derived from demand surcharges that are used to fund distribution infrastructure like substations, transformers, feeders, poles as well as high voltage transmission lines. Commercial and industrial customers must pay these demand surcharges to utilities, but they can avoid power capacity charges by supplying their own “behind the meter” energy during periods of demand surcharge. One option is to purchase and run a diesel generator (now EPA-restricted) or buy a battery energy storage system (BESS) to supply this power “off-grid.” A typical BESS system will take 10-12 years of power savings to become return on investment positive, and many customers don't know if they'll be in the same site for a decade. Carrying costs (interest payments, insurance, siting, permitting, maintenance) are substantial, and even though a BESS is only utilized 3-5% of the month, the system will need to be augmented to deal with duty-cycle degradation and changes to power demands.

Accordingly, there is a need for a mobile grid, including flexible power storage and mobile delivery methods for industrial power supply, which can be easily integrated to bring megawatt-scale portable energy storage to alleviate the current grid, and allow for alternative forms of power generation to be fully captured. Further, combining output from various power sources at commercial and industrial sites based on programmable settings is desired to offset demand surcharges.

### SUMMARY

One aspect of the subject matter described in this disclosure may be embodied in an electrical combiner system. The electrical combiner system can include a first breaker in electrical communication with a first power source, wherein the first breaker comprises a first programmable controller. The electrical combiner system can include a second breaker in electrical communication with a second power source, wherein the second breaker comprises a second programmable controller. The electrical combiner system can include a site controller in electronic communication with the first breaker and the second breaker, wherein the site controller is configured to synchronize a voltage of the first power source and a voltage of the second power source, including at least one of voltage magnitude, frequency, and phase angle, to output a combined voltage. The electrical combiner system can include a network device in communication with a network, wherein the network device is in electronic communication with at least one of the first programmable controller and the second programmable controller.

In various aspects, the first power source is a generator.

In various aspects, the second power source is a battery.

In various aspects, the first breaker and the second breaker are motor-operated.

In various aspects, the first programmable controller is configured to control a state of the second breaker between a first open position and a first closed position. In various aspects, the second programmable controller is configured to control a state of the second breaker between a second open position and a second closed position. The first programmable controller and the second programmable controller can be in electronic communication with the site controller.

In various aspects, the site controller is configured to selectively operate the first breaker and the second breaker to provide at least one of: (i) an islanded mode in which a power distribution system is disconnected from a utility grid; and (ii) a grid-connected mode in which at least one of the first power source and the second power source is synchronized with the utility grid.

In various aspects, the network device is configured to communicate with a remote control application to receive commands for breaker operation and transmit telemetry data from at least one of the first programmable controller and the second programmable controller.

In various aspects, the electrical combiner system further includes a housing defining a volume. The first breaker, the second breaker, the site controller, and/or the network device can be disposed in the housing.

In various aspects, the housing comprises a plurality of modular enclosures, each modular enclosure including a respective motor-operated breaker and being configured to couple to the site controller for scalable deployment of additional power sources.

In various aspects, the electrical combiner system further includes a plurality of edge compute devices, each edge compute device operatively coupled to a respective power asset and configured to translate an industrial protocol into a network-accessible endpoint for communication with the site controller.

In various aspects, each network-accessible endpoint exposes a plurality of telemetry channels and writable command channels, and wherein the site controller is configured to discover each network-accessible endpoint, ingest metadata describing the telemetry channels, and enable monitoring and control of the respective power asset.

In various aspects, the site controller is configured to inject telemetry obtained from the first programmable controller, the second programmable controller, and one or more edge compute devices into a telemetry database hosted in a virtual private cloud.

In various aspects, the telemetry database is queryable and is further configured to store issued control commands as writable telemetry channels.

In various aspects, the electrical combiner system further comprises a plurality of quick-disconnect electrical connectors, each quick-disconnect electrical connector configured for tool-less connection and disconnection of a power source or load cable.

Another aspect of the subject matter described in this disclosure may be embodied in a method of operating an electrical combiner system. The method can include receiving, at a first breaker, electrical power from a first power source. The method can include receiving, at a second breaker, electrical power from a second power source. The method can include controlling a first programmable controller of the first breaker and a second programmable controller of the second breaker. The method can include synchronizing, by a site controller in electronic communication with the first programmable controller and the second programmable controller, at least one of a voltage magnitude, frequency, and phase angle of the first power source and the second power source. The method can include outputting, from the electrical combiner system, a combined voltage from the first power source and the second power source.

In various aspects, the method can further include transmitting, via a network device, a remote command from a control application to the site controller, wherein the site controller relays the remote command to at least one of the first programmable controller and the second programmable controller to selectively open or close the respective first breaker or second breaker.

In various aspects, the synchronizing further includes monitoring, at the site controller, a state of health of at least one battery, an operating status of at least one generator or inverter, and real-time load demand, and adjusting breaker operation based on at least one of the state of health of at least one battery, the operating status of at least one generator or inverter, and the real-time load demand.

In various aspects, the method can further include operating the electrical combiner system in (i) an islanded mode in which the electrical combiner system supplies power to a power distribution system without a utility grid connection, (ii) a grid-connected mode in which the electrical combiner system synchronizes the first power source or the second power source with a utility grid, and/or (iii) a peak-shaving mode in which a battery discharges to reduce utility grid draw during high demand periods.

In various aspects, the method can further include executing, by the site controller, an orchestration algorithm that schedules operation of the first power source and the second power source based on at least one of: (i) a forecasted load profile, (ii) a utility-provided operating constraint, or (iii) a learned optimization policy trained over historical asset performance.

Another aspect of the subject matter described in this disclosure may be embodied in a method of power delivery. The method can include generating, by a power generation system, electrical power. The method can include connecting a mobile power system in electrical communication to the power generation system. The method can include transferring, by the power generation system, the electrical power to the mobile power system. The method can include transporting the mobile power system to a power delivery site, wherein the power delivery site comprises an electrical combiner system. The method can include connecting the mobile power system in electrical communication to the electrical combiner system. The method can include transferring, by the mobile power system, the electrical power to the electrical combiner system.

### BRIEF DESCRIPTION OF THE DRAWINGS

Other systems, methods, features, and advantages of the present invention will be apparent to one skilled in the art upon examination of the following figures and detailed description. Component parts shown in the drawings are not necessarily to scale and may be exaggerated to better illustrate the important features of the present invention.

FIG. 1 is a block diagram of an example mobile grid system, according to an aspect of the invention.

FIG. 2 is a block diagram of an example site data architecture illustrating communication links among various components of a mobile grid system, according to an aspect of the invention.

FIG. 3 is a schematic view of an electrical combiner system, according to an aspect of the invention.

FIG. 4A and FIG. 4B are front perspective and rear perspective views, respectively, of a breaker and associated conductive pathways for an electrical combiner system, having lug-and-screw connectors, according to an aspect of the invention.

FIG. 4C and FIG. 4D are front perspective and rear perspective views, respectively, of a breaker and associated conductive pathways for an electrical combiner system, having quick-disconnect style connectors, according to an aspect of the invention.

FIG. 5 is a schematic view of a modular electrical combiner system having a site controller in a first housing and electrical combiner systems in a plurality of other housings, according to an aspect of the invention.

FIG. 6A, FIG. 6B, and FIG. 6C are flow charts for a method of operating an electrical combiner system, according to an aspect of the invention.

### DETAILED DESCRIPTION

Reference will now be made to the exemplary embodiments illustrated in the figures, and specific language will be used herein to describe the same. It will nevertheless be understood that no limitation of the scope of the disclosure is thereby intended. Alterations and further modifications of the inventive features illustrated herein, and additional applications of the principles of the disclosure as illustrated herein, which would occur to one skilled in the relevant art and having possession of this disclosure, are to be considered within the scope of the disclosure.

Systems, methods, apparatus, and devices for a mobile grid system are disclosed. The mobile grid system can include a power generation system, such as a power plant, solar farm, wind farm, or any other suitable system for generating electrical power. In various aspects, the mobile grid system can include a mobile power system, such as a trailer with batteries disposed thereon. The mobile power system can be transported via trailer or internal driving mechanisms. In various aspects, the mobile grid system includes an electrical combiner system at a power delivery site. The electrical combiner system can be configured to deliver electrical power to a power distribution system (“Load”) at the power delivery site.

In various aspects, the electrical combiner system includes a housing to store various electronic components, including electronic components as would be customary to a person of ordinary skill in the art to be used with power boxes and breaker boxes. In various aspects, the electrical combiner system includes a plurality of breakers, wherein each of the plurality of breakers is in electrical communication with one or more power sources and/or energy storage devices. In various aspects, the electrical combiner system includes a first breaker. The first breaker may be in communication with a first power source comprising a first voltage. The first breaker can include a first programmable controller. The first programmable controller can be in communication with a network device connected to a network. In various aspects, the first power source is a generator, a battery, a solar array, or any other suitable power source. In various aspects, the first power source can be an electrical grid.

In various aspects, the electrical combiner system includes a second breaker. The second breaker may be in communication with a second power source comprising a second voltage. The second breaker can include a second programmable controller. The second programmable controller can be in communication with the network device connected to the network. In various aspects, the second power source is a generator, a battery, a solar array, or any other suitable power source. In various aspects, the first power source is different than the second power source, and the first voltage can be different than the second voltage.

In various aspects, the network is at least one of a local network, a cellular network or a non-terrestrial network. The network can be configured to transmit a command to the first programmable controller and the second programmable controller. This allows for the first programmable controller and the second programmable controller to be dynamically controlled based on the type of power source used with each breaker. The dynamic control creates an opportunity for customization and optimization at each power delivery site based on the power sources available. In various aspects, the command can include remotely closing or opening the first breaker and/or the second breaker.

As used herein, the term “asset” refers broadly to any electrical power component, device, or subsystem that can generate, store, consume, convert, or otherwise affect electrical energy within the mobile grid system. Assets may include, without limitation, power generation units (e.g., generators, solar arrays, wind turbines, fuel cells), energy storage devices (e.g., battery energy storage systems, capacitors), power conversion equipment (e.g., inverters, rectifiers, transformers), protective devices (e.g., breakers, relays, meters), and environmental or support systems (e.g., HVAC units, heaters, or controllers). Each asset can be coupled to the system directly or via an edge compute device that exposes the asset's operational state and command channels to the site controller or other supervisory control system.

As used herein, the term “edge compute device” refers to a localized computing unit that is operatively coupled to an asset. The edge compute device can translate native or legacy industrial communication protocols (e.g., MODBUS RTU/TCP, CAN bus/J1939, IEC 61850, or vendor-specific protocols) into modern, network-accessible request/response interactions. Each edge compute device may persist current asset data, expose it as a set of channels, and provide a discoverable network endpoint accessible by the site controller or other supervisory system.

As used herein, the term “channel” refers to a logical data path that represents a measurable parameter or control command associated with an asset. Channels can include, for example, telemetry parameters (e.g., voltage, current, state of charge, temperature, breaker position) and writable parameters (e.g., setpoints, breaker open/close commands). Each channel may be identified by a name, description, datatype, units, and scaling or mapping information, and may be updated at a defined sampling frequency.

As used herein, the term “endpoint” refers to a discoverable network resource hosted by an edge compute device. An endpoint may expose one or more channels through a request/response interface (e.g., HTTP, CoAP, or a similar protocol), allowing the site controller or other supervisory system to retrieve telemetry (e.g., via GET requests) or issue commands (e.g., via PUT or POST requests). Endpoints may be discoverable on a site's local network and may include metadata describing the supported channels to facilitate automated orchestration.

As used herein, the term “power delivery site” refers to the physical location where one or more assets, an electrical combiner system, and a site controller are installed and interconnected with local electrical loads. A power delivery site may include fixed infrastructure, mobile systems, or combinations thereof, and may serve as the operational hub for delivering synchronized power from multiple sources to a power distribution system.

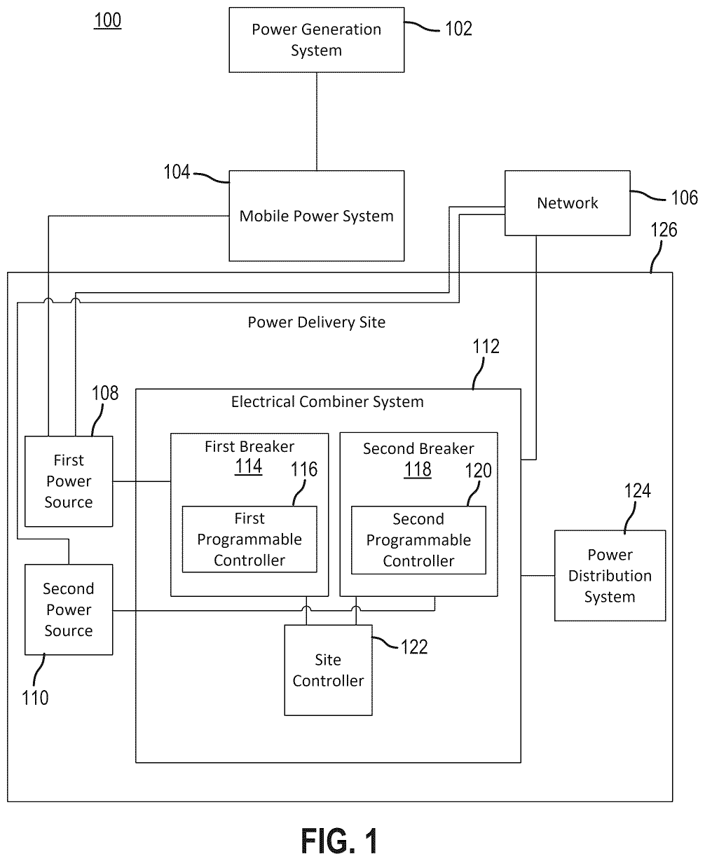

FIG. 1 illustrates an example mobile grid system 100. The system 100 includes a power generation system 102, a mobile power system 104, a network 106, a power delivery site 126, a first power source 108, a second power source 110, an electrical combiner system 112, a first breaker 114, a second breaker 118, a first programmable controller 116, a second programmable controller 120, a site controller 122, and a power distribution system 124. It should be understood that, in various aspects, one or more of these elements may be omitted, substituted, or combined with other elements, without departing from the scope of the present disclosure.

The power generation system 102 may be any installation configured to generate electrical power, such as a gas-fired or coal-fired plant, a solar farm, a wind farm, a nuclear facility, or a hydroelectric plant. The power generation system 102 may provide bulk generation to the grid or operate as an isolated plant. In various aspects, the generation system 102 supplies power to the mobile power system 104 during periods of overproduction to capture energy that would otherwise be curtailed or wasted.

The mobile power system 104 may be implemented as a trailer, skid-mounted system, or self-propelled vehicle including one or more energy storage units. The energy storage can include a battery energy storage system (BESS) such as lithium-ion batteries, sodium-sulfur batteries, nickel-manganese cobalt batteries, supercapacitors, or flow batteries. In various aspects, the mobile power system 104 may include integrated generation devices, such as hydrogen fuel cells or compact diesel/natural gas gensets.

The mobile power system 104 may further include inverters, rectifiers, and/or transformers to provide DC-to-AC, AC-to-DC, DC-DC, or AC-AC conversion. The inverter can be disposed between a battery or other DC source and the electrical combiner system to perform DC-to-AC conversion. The system may also include environmental controls, such as HVAC, heaters, or dehumidifiers, to maintain stable operating conditions for batteries and electronics. The mobile power system 104 can be charged at the power generation system 102, transported to the power delivery site 126, and coupled to the electrical combiner system 112 to supply supplemental or backup power to the local distribution network.

The network 106 enables communication among one or more controllers or other electrical devices within the system 100. In various aspects, the network 106 may include a local Ethernet-based hardline network, a wireless LAN, a cellular backhaul, or a satellite/non-terrestrial link. For security, the network 106 may operate within a virtual private network (VPN) and restrict access via single sign-on (SSO) authentication. The network 106 can support telemetry streaming, control command transmission, and firmware updates to controllers in the system.

The first power source 108 and second power source 110 may each be implemented as any discrete asset capable of providing electrical power. For example, the first power source 108 can include a grid interconnection at medium voltage, and the second power source 110 can include a renewable array, generator, or battery bank. In various aspects, the first and second power sources 108, 110 operate at different voltage levels or frequencies, requiring synchronization before combination. Either or both may be permanently installed at the power delivery site 126, or temporarily connected mobile assets.

The electrical combiner system 112 serves as the hub where multiple sources are electrically connected and combined. The electrical combiner system 112 can be referred to herein as an AC combiner. The electrical combiner system 112 may include busbars, protective relays, sensors, and multiple input/output connection points. Inputs from the first power source 108, second power source 110, and/or mobile power system 104 can be selectively coupled to the combiner bus, which outputs three-phase AC power to the power distribution system 124. One or more transformers may be interposed between AC sources and the AC combiner to adapt voltage levels or provide isolation as required for site-specific configurations.

The electrical combiner system 112 can provide a synchronized three-phase AC output to the power distribution system 124. The electrical combiner system 112 can be configured to receive real-time status information from inverters, generators, other distributed assets, and the grid via Ethernet or other digital communication links. Based on this information, the electrical combiner system 112 and its associated controllers can issue connection and disconnection commands to the respective assets (i.e., power sources) to optimize site operation. In various aspects, startup occurs in a fully islanded mode in which the combiner coordinates initial power delivery from available local sources. For example, the system may dispatch a generator alone, a generator and battery combination, or a battery/inverter alone, based on forecasted load and source availability.

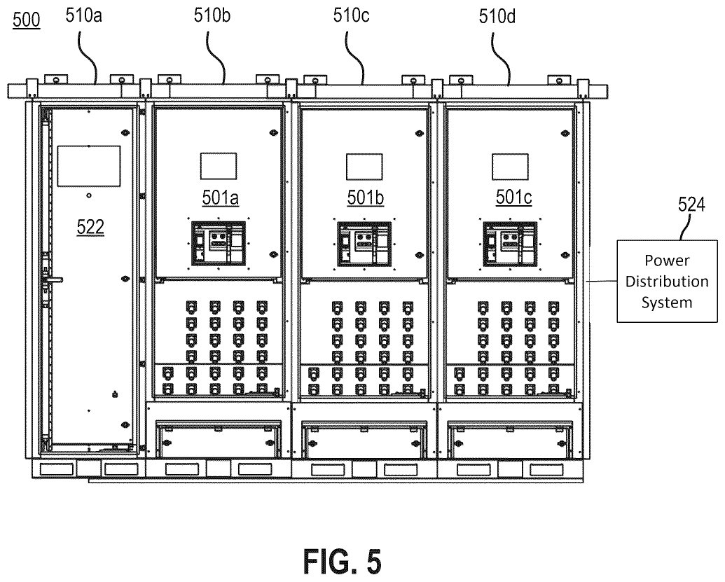

The electrical combiner system 112 may also incorporate surge protection devices, adjustable overcurrent protection devices (OCPDs), and environmental control systems. In modular configurations, multiple combiner cabinets may be deployed, each handling different source combinations (e.g., see FIG. 5).

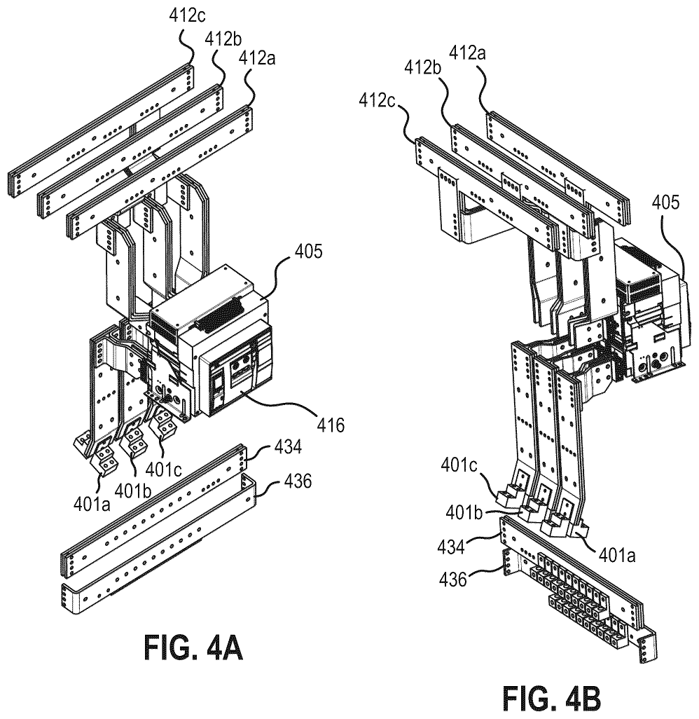

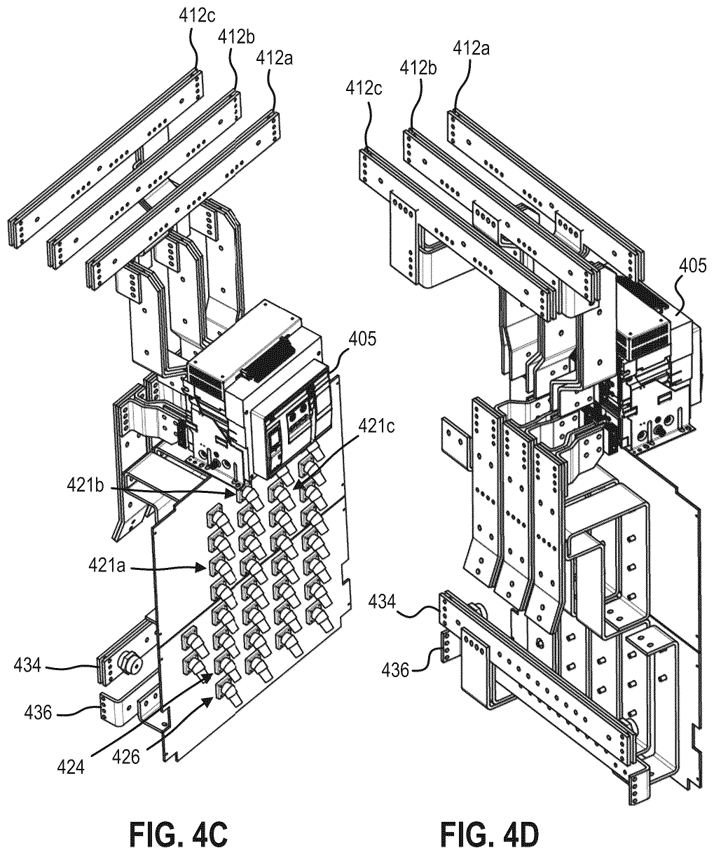

The first breaker 114 can selectively connect the first power source 108 to the combiner bus. The first breaker 114 can be a motor-operated power circuit breaker configured for remote operation. In various aspects, the first breaker 114 and/or the second breaker 118 can be similar to the motor-operated breaker 405 described with respect to FIG. 4A through FIG. 4D. The first programmable controller 116 can monitor the breaker status and receives commands from the site controller 122 to open or close the first breaker 114. The controller 116 may also execute phase synchronization by aligning voltage magnitude, frequency, and phase angle between the source and the combiner bus prior to closure. The breaker controller 116 may itself be configured to perform phase synchronization between the voltage of its associated power source and the combiner bus prior to closure, thereby ensuring safe and reliable connection of asynchronous sources.

The second breaker 118 can operate similarly to the first breaker 114 but controls the second power source 110. The second programmable controller 120 can receive open/close commands from the site controller 122 and provides real-time telemetry such as breaker position, current magnitude, and detected fault conditions. Both programmable controllers 116, 120 can be commanded locally or remotely via the network 106. The programmable controllers 116, 120 can provide redundancy for switching operations. In various aspects, the programmable controllers 116, 118 can include a commercially available secondary controller, such as a DEIF controller or a functionally similar device, that is configured to monitor, regulate, and coordinate operation of the power source and associated breakers. The programmable controllers 116, 120 may include one or more processors, memory, communication interfaces, and input/output circuitry, and may be programmed to execute logic for synchronization, load sharing, protection, fault detection, and remote monitoring. The controllers 116, 120 may further be configured to communicate with the site controller 122 or other supervisory control system to receive operating commands, transmit status information, and adaptively adjust system parameters based on measured conditions. Although a DEIF secondary controller is one example, any suitable programmable control unit capable of performing equivalent control and communication functions may be employed. It should be understood that while two breakers are illustrated for purposes of example, the architecture is not so limited, and the disclosed systems and methods can be scaled to incorporate any number of breakers without departing from the scope of the present disclosure.

The site controller 122 can function as the supervisory control and orchestration system. Inputs to the site controller 122 can include:
(1) State of health (SoH) and state of charge (SoC) of batteries.
(2) Operating status of generators, inverters, and grid tie.
(3) Breaker states and fault indicators.
(4) Real-time factory or customer load demands.
(5) Utility-provided operating constraints or schedules.

Additional inputs may include grid status indicators, forecasted schedules received from a utility, and operating schedules provided by a customer system.

Outputs of the site controller 122 can include:
(1) Breaker control commands (open/close).
(2) Inverter and generator setpoints (active/reactive power).
(3) Comprehensive telemetry streams including all measured inputs and generated outputs (e.g., battery state of charge, temperature, health metrics, inverter and generator setpoints, breaker status), which may be transmitted to cloud-hosted databases.
(4) Orchestration AI outputs for asset scheduling and demand response.
(5) Fault response and orchestration.

The site controller 122 may operate autonomously or under supervisory remote operator input. The site controller 122 can include one or more controllers (e.g., processors) and one or more tangible, non-transitory memories capable of implementing digital or programmatic logic. In various aspects, for example, the one or more controllers are one or more of a general purpose processor, digital signal processor (DSP), application specific integrated circuit (ASIC), field programmable gate array (FPGA), or other programmable logic device, discrete gate, transistor logic, or discrete hardware components, or any various combinations thereof or the like. In various aspects, the site controller 122 controls, at least various parts of, the state of, and operation of various components of, the system 100.

The power distribution system 124 can include loads such as stadiums, industrial facilities, warehouses, airports, schools, or residential neighborhoods. The power delivery site 126 can refer to the physical location where the combiner system 112 and site controller 122 are installed and connected to local loads.

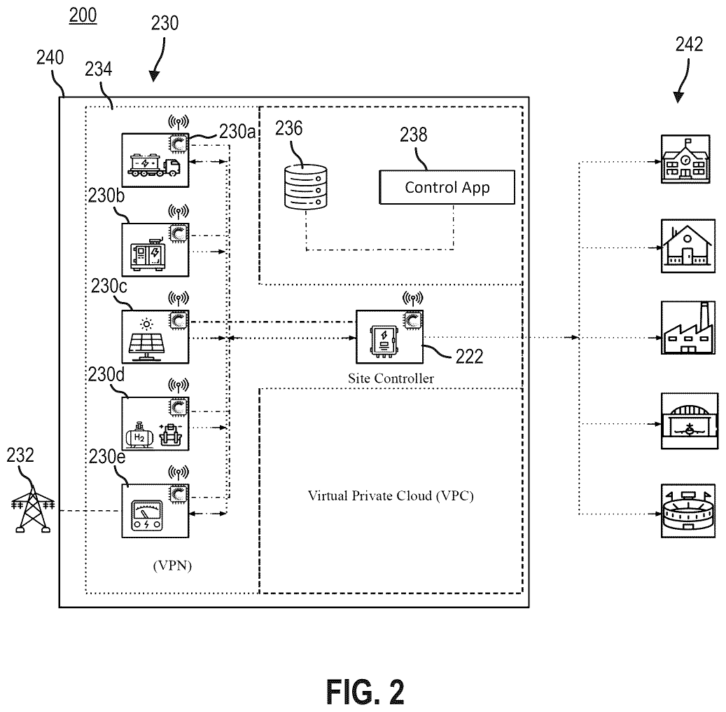

FIG. 2 illustrates a block diagram of an example site data architecture 200 illustrating communication links among power generation and storage assets 230, a site controller 222, a network 234, a telemetry database 236, and a control application 238. A plurality of power generation and storage assets 230 may be present, including a mobile power delivery system 230a, generator 230b, solar array 230c, hydrogen fuel cell 230d, and/or inverter 230e.

The inverter 230e may be configured to draw power from the grid 232 and supply it to the site. Each asset 230 can communicate with the site controller 222 via a secure network 234, such as a VPN.

The site controller 222 can store telemetry in a database 236, which may be cloud-hosted in a virtual private cloud (VPC). The site controller 222 can also receive commands from a control application 238. The site controller 222 can relay those commands to the respective assets and/or to one or more breaker controllers.

In various aspects, the system includes a plurality of edge compute devices, each operatively coupled to a respective power asset (e.g., BESS, generator, inverter, solar array, fuel cell, industrial meter, or breaker relay). Each edge compute device can execute protocol adapter software (e.g., MODBUS RTU/TCP, CAN bus/J1939, IEC 61850, DNP3, or vendor-specific SDKs) to obtain native asset data and exposes a self-describing network endpoint that presents the asset as a set of named channels having declared datatypes, units, and scaling. The endpoint persists current channel values locally and can be discoverable by the site controller 222 on the hardline Ethernet (or via a network) at the power delivery site.

The endpoint supports a request/response interface (e.g., HTTP or CoAP) whereby GET requests return telemetry channel values and PUT/POST requests may write writable channels corresponding to asset commands. In certain aspects, write operations are permitted only when the operator is authenticated via single sign-on (SSO) within a virtual private network (VPN). In various aspects, the edge compute device can update channel values at twice (2×) the underlying asset control-loop frequency. In various aspects, the site controller can request telemetry at twice the endpoint update frequency.

Each edge compute device can be commissioned with a configuration file that defines the channels to be exposed and any scaling or mapping. The site controller 222 can periodically discover endpoints, ingest their self-descriptions, and register or deregister assets as they join or leave the site, thereby enabling hot-plug mobility of assets between sites with minimal setup. Telemetry obtained from endpoints can be normalized into time-stamped records (e.g., epoch-keyed JSON) and injected into a site or cloud telemetry database hosted in a virtual private cloud (VPC), which may be queried using industry-standard methods (e.g., SQL) for monitoring, analytics, and orchestration.

The site controller 222 can poll each available channel on discovered assets and inject timestamp-value pairs into a telemetry database that may be hosted within a virtual private cloud (VPC) (e.g., on a public cloud provider). The database may maintain backups and be queryable using industry-standard methods (e.g., SQL) for analytics, reporting, and compliance.

The control application 238 can interact with the site controller 222 to request telemetry (e.g., via GET, which the site controller 222 may satisfy from its database or proxy to an endpoint) and to issue commands (e.g., via PUT), which the site controller 222 routes to the appropriate writable telemetry channels on the endpoints. In various aspects, commands are permitted only when the operator is authenticated via SSO. Issued commands can be recorded into the telemetry database in the same manner as sensor channels.

Each endpoint can self-describe its available channels, including names, descriptions, datatypes, units, and scaling/mapping, enabling the site controller 222 to discover new assets, ingest their schemas, and begin interaction with minimal setup. The network design supports assets going offline (e.g., moved to another site) and new assets joining; since each endpoint carries sufficient metadata, hot-swap and mobility between power delivery sites are facilitated.

The site controller 222 may be in electronic communication with loads 242 (stadiums, warehouses, industrial facilities, schools, airports, residential neighborhoods, etc.). In this way, the controller can manage site-level orchestration between distributed assets and demand.

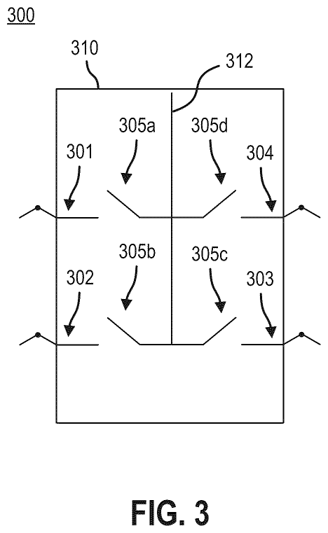

FIG. 3 illustrates an example electrical combiner system 300. The combiner system 300 can include a cabinet or housing 310. The housing 310 can be a NEMA 3R-rated enclosure, which may be pad-or wall-mounted. Inside the housing 310, the combiner system 300 can include through-bussing 312 (also referred to as a combiner bus). The through-bussing 312 can be a conductive pathway, such as a bus bar or the like. The through-bussing 312 can be sized at least twice the largest expected input rating (e.g., up to 3200A or more). In various aspects, the AC combiner system 300 is rated for between 200A and 3200A. In various aspects, the AC combiner system 300 is rated for between 1000A and 3200A. In various aspects, the AC combiner system 300 is configured to automate switching functions of the system. For example, the combiner system 300 can include mechanically operated breakers that are communicatively coupled to a site controller, thereby enabling the site controller to selectively actuate the breakers as needed to manage power distribution and operational states of the system.

Input and output connections may be facilitated through high-capacity electrical connectors configured for rapid connection and disconnection of power cables. In various aspects, the connectors can include quick-connect style devices, such as multi-pin or single-pole devices rated for hundreds of amps. Non-limiting examples include PowerSafe P3 connectors or Camlocks, although other functionally similar connectors may be used.

The combiner system 300 can include mechanically operated breakers (e.g., first motor-operated breaker 305a, second motor-operated breaker 305b, third motor-operated breaker 305c, and motor-operated breaker 305d). The breakers can be controlled by one or more breaker controllers. In various aspects, each breaker 305a, 305b, 305c, 305d is independently controlled by a breaker controller. Each breaker 305a, 305b, 305c, 305d may be sized for up to 3200A input/output and/or 600-1200A for generator connections. However, each breaker 305a, 305b, 305c, 305d can be sized for any electrical connection as desired, depending on the local power needs.

In various aspects, the system 300 includes a first connection 301 coupled to the first breaker 305a. The system 300 can further include a second connection 302 coupled to the second breaker 305b. The system 300 can further include a third connection 303 coupled to the third breaker 305c. The system 300 can further include a fourth connection 304 coupled to the fourth breaker 305d. In various aspects, the first connection 301 can be configured as an input. In various aspects, the second connection 302 can be configured as an output. In various aspects, the third connection 303 can be configured as an input, for example for a generator or any other suitable power source. In various aspects, the fourth connection 304 can be configured as an input. It should be understood that the connections 301-304 can be configured as an input, an output, or a bidirectional input/output. In various aspects, the connections 301-304 can be adapted to receive AC power from any suitable power source and/or to supply AC power to any suitable load.

The combiner system 300 can be designed for automated switching of functions, with overcurrent protection devices (OCPDs) and associated relays that may be configured or adjusted for site-specific customization. Such OCPDs may include circuit breakers, fuses, or electronic protective relays. Breaker operation may be remotely commanded by the site controller 122 to manage source selection, fault isolation, and load balancing.

FIG. 4A and FIG. 4B illustrate front perspective and rear perspective views, respectively, of a breaker and associated conductive pathways for an electrical combiner system including an example motor-operated breaker 405, a plurality of conductive pathways (e.g., conductive pathway 412a, conductive pathway 412b, and conductive pathway 412c; referred to generally as conductive pathways 412), and associated connections 401a, 401b, 401c. The breaker 405 can be an air circuit breaker, such as an A25 Series Power Circuit Breaker, or the like. The breaker 405 can be any suitable motor-operated breaker. The breaker 405 can include a dedicated breaker controller 416. The breaker controller 416 can be similar to the programmable controller 116 of FIG. 1 in accordance with various aspects. The breaker 405 may be actuated by an electric motor (e.g., CB713 motor operator or the like) under command from the breaker controller 416 (such as a DEIF secondary controller or the like). Input/output conductors may be connected via the connections 401a, 401b, 401c, which can be lug-and-screw terminals or any other suitable connection point.

Each breaker 405 includes three primary conductive pathways 412, which may correspond to the three hot phases (e.g., phases A, B, and C) of a three-phase AC line. In addition, the system can include a neutral bus bar 434 (or other suitable conductive structure) for electrically connecting the neutral terminals of the various input and/or output connections, and a ground or earth bus bar 436 (or the like) for electrically connecting the earth terminals of the input and/or output connections. Thus, for each input/output connection, the system provides a full set of conductors—phase, neutral, and ground—ensuring compliance with standard three-conductor AC cabling. Through-bussing can be used to connect the conductive pathways 412 in parallel in various aspects where multiple breakers 405 are coupled together to combine a plurality of power sources to generate a combined power output.

With combined reference to FIG. 1 and FIG. 4A, in operation, the conductive pathways 412 allow each breaker 405 to selectively connect or disconnect one or more power sources and/or loads. When the breaker controller 416 receives a command signal from the site controller 122, the motor operator drives the breaker contacts to close, thereby coupling the conductive pathways 412 to the connections 401 and enabling current flow. The conductive pathways 412 can be coupled to through-bussing (e.g., see through-bussing 312 of FIG. 3) for combining voltage from a plurality of breakers. The neutral bus bar 434 provides a common return path across all connected inputs and outputs, while the earth bus bar 436 establishes a shared grounding reference to maintain personnel safety and system protection.

In various aspects, the site controller 122 can orchestrate these switching operations based on real-time information such as the state of health of assets, grid conditions, breaker status, and load demand. In various aspects, the site controller 122 may issue breaker control signals, inverter and generator setpoints, and telemetry updates to the cloud. The breaker controllers 416 can execute these commands at the individual breaker level, including functions such as phase synchronization prior to closure. By coordinating the conductive pathways 412 with the neutral and ground buses 434, 436, the site controller 122 ensures that multiple sources (e.g., grid, generator, inverter, battery) can be connected or disconnected safely and efficiently, thereby enabling the AC combiner system to deliver three-phase power to the power distribution system 124 under automated control.

In certain operating modes, the site controller 122 can configure the system for fully islanded operation, in which the power delivery site is temporarily disconnected from the utility grid and supplied exclusively by local assets such as generators, inverters, and battery storage. In this mode, the site controller 122 may determine, based on forecasted load and available state of charge, whether to dispatch generation only, battery only, or a combination of sources. In other modes, the site controller 122 can perform peak shaving by discharging the battery during high-demand periods to reduce utility draw. The site controller 122 may also execute load shifting by charging the battery during off-peak hours in anticipation of constrained operating windows.

The site controller 122 can further respond to external operating protocols received from a utility or customer system. For example, the utility may transmit schedules specifying maximum permissible grid draw during certain hours. In such cases, the site controller 122 can proactively command the inverter to inject battery power, adjust generator setpoints, or disconnect selected loads to remain within the constraint. In other aspects, the site controller 122 may employ predictive or machine learning algorithms to develop its own operating schedule based on historical load patterns, renewable generation forecasts, and asset health metrics. Such utility protocols may be preprogrammed, specifying for example that grid draw must not exceed a predetermined threshold during designated hours. Similarly, customer systems may provide operating schedules or load constraints, which the site controller 122 incorporates into its orchestration logic.

During continuous operation, the site controller 122 may maintain a “resting” or standby state in which all assets are electrically coupled to the combiner but operate at minimal output until additional capacity is required. Upon detecting an increase in load, the controller can instantaneously dispatch additional inverter capacity or generator power. Through Ethernet or other networked connections, the site controller 122 can also coordinate with battery controllers, generator controllers, or transformer monitoring systems to ensure safe and efficient transitions between sources. In various aspects, the site controller 122 may directly instruct the battery controller to disconnect the battery from the combiner bus.

FIG. 4C and FIG. 4D illustrate front perspective and rear perspective views, respectively, of a portion of an AC combiner system, which is generally similar to the AC combiner shown in FIG. 4A and FIG. 4B. However, in the variant of FIG. 4C and FIG. 4D, the input and output connections are implemented as quick-disconnect style connectors, such as camlock connectors, instead of traditional lug-and-screw terminals. For example, the conductive pathways 412 may terminate at connectors 421a, 421b, and 421c, while the neutral bus 434 and ground bus 436 may terminate at connectors 424 and 426, respectively. This configuration enables rapid field deployment and safe, tool-less connection and disconnection of power cables. As with the embodiment of FIG. 4A and FIG. 4B, the configuration of FIG. 4C and FIG. 4D supports automated breaker operation, synchronization of phases, and telemetry reporting to the site controller 122.

FIG. 5 illustrates a modular deployment of an electrical combiner system 500 wherein a first housing 510a houses the site controller 522, and a plurality of other housings (e.g., a second housing 510b, a third housing 510c, and a fourth housing 510d) house respective AC combiner units (e.g., AC combiner unit 501a, AC combiner unit 501b, and AC combiner unit 501c). Although illustrated as having three AC combiner units, it should be understood that any number of AC combiner units can be used depending on the number of inputs and outputs being used at the site. Each AC combiner unit can manage a different power source or set of power sources. This architecture allows scaling the system based on available assets and required load capacity.

In various aspects, each housing 510a, 510b, 510c, 510d may include environmental controls such as heaters, lighting, and ventilation systems to ensure reliable year-round operation.

In operation, the site controller 522 supervises the overall system. The site controller 522 can request telemetry from assets, stores the data in the database 236, and runs orchestration algorithms to determine the optimal asset scheduling. The site controller 522 may operate in one of several modes. For example, in a first mode (also referred to as an islanded mode), the system operates independently, supplying power from local assets only. In a second mode (also referred to as a grid-connected mode), the system integrates local assets with the grid. In a third mode (also referred to as a peak shaving mode), the system uses stored energy to reduce peak grid draw. In a further mode (also referred to as a backup mode), the system supplies emergency power to the load during outages.

The site controller 522 may also accept signals from the utility specifying constraints (e.g., maximum allowable draw). In such cases, the site controller 522 can pre-charge batteries and dispatch them during constrained periods. Machine learning algorithms may be used to refine these schedules to improve cost efficiency and reliability. In various aspects, orchestration AI models can be trained over the optimization space defined by the available assets and site objectives, ranging from simple charge/discharge schedules for BESS to multi-objective policies that consider outage probability, recovery time, energy pricing, and demand response performance.

Each AC combiner unit 501a, 501b, 501c can provide three-phase synchronized output power to the power distribution system 524. The breaker controllers synchronize phase and frequency of each source before connecting, ensuring smooth transitions. Each AC combiner unit 501a, 501b, 501c may also independently and selectively disconnect sources in response to faults or maintenance requirements.

By coordinating multiple mobile and stationary sources, the system 500 provides a flexible, transportable, and intelligent microgrid capable of supporting a wide range of commercial, industrial, and emergency applications.

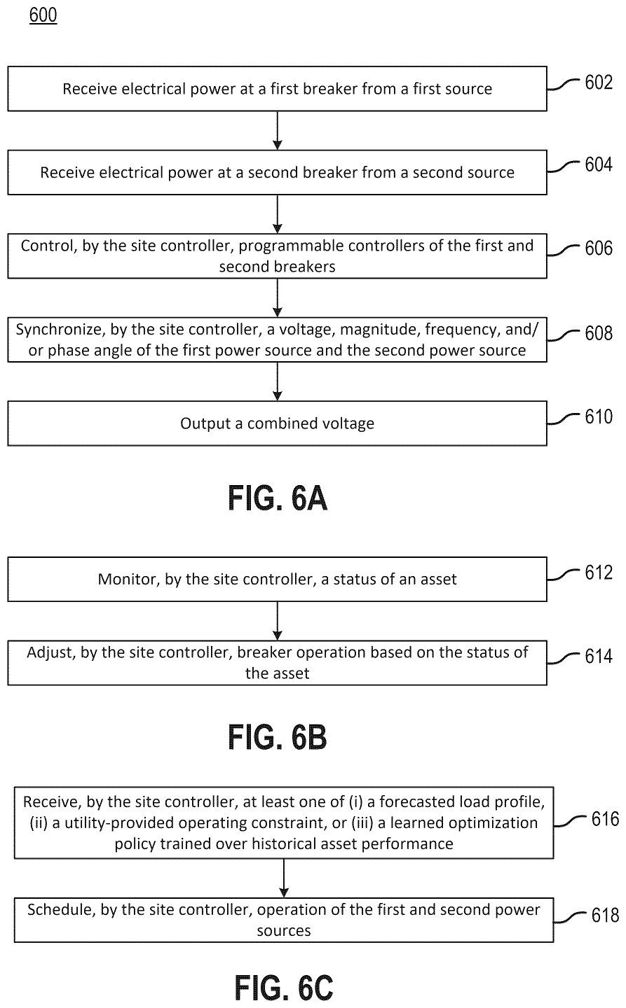

FIG. 6A-6C illustrate an example method 600 of operating an electrical combiner system, in accordance with various aspects of the present disclosure. The method 600 may be implemented, for example, in the mobile grid system 100 described with reference to FIG. 1 and the site data architecture 200 described with reference to FIG. 2. Although illustrated as a sequence of discrete steps, it should be understood that the method 600 may include additional steps, fewer steps, or steps performed in different orders without departing from the scope of the disclosure.

Referring to FIG. 6A, at step 602, the method includes receiving electrical power at a first breaker (e.g., breaker 114 of FIG. 1) from a first power source 108. At step 604, the method further includes receiving electrical power at a second breaker (e.g., breaker 118 of FIG. 1) from a second power source 110. The first and second power sources 108, 110 may be any suitable assets such as a generator, a battery, an inverter, or a grid interconnection, as described previously.

At step 606, the method includes controlling, by the site controller 122, the programmable controllers 116, 120 of the first and second breakers. Control may include receiving a command via the network 106 (e.g., from a control application 238 of FIG. 2), and transmitting the command to the programmable controllers 116, 120 to selectively open or close the respective breakers. In some implementations, the programmable controllers 116, 120 may be configured to perform local synchronization or protection functions, while the site controller 122 issues supervisory control commands.

At step 608, the method includes synchronizing, by the site controller 122, voltage magnitude, frequency, and phase angle of the first power source 108 and the second power source 110, such that the two sources are aligned prior to combining. In certain aspects, the synchronization function may be performed cooperatively, with the site controller 122 executing orchestration logic and the programmable controllers 116, 120 executing local breaker-level synchronization.

At step 610, the method includes outputting, from the electrical combiner system 112, a combined voltage comprising the synchronized power from the first and second power sources. The combined voltage may be supplied to the power distribution system 124 for delivery to local loads at the power delivery site 126.

Referring now to FIG. 6B, the method 600 may include monitoring, at the site controller 122, a status of an asset (step 612). The monitored status may include, for example, a state of health of a battery, an operating status of a generator or inverter, or real-time load demand. Based on the monitored parameters, the site controller 122 may adjust breaker operation (step 614) to optimize performance, prevent overloads, or isolate faults.

In various aspects, the site controller 122 executes step 614 by issuing open/close commands, transfer sequences, interlocks, and/or timing adjustments to one or more breakers to effect source selection, load sharing, and protection responses based on the monitored parameters from step 612. By way of non-limiting example:

Battery State-of-Charge (SoC) high (e.g., ≥95-100%). In response to determining that a battery source exhibits a high SoC, the site controller 122 may command the associated breaker to close to prioritize discharge for peak shaving or islanded operation, and, where applicable, may command a generator-source breaker to open or remain open to avoid unnecessary runtime. The site controller 122 can further schedule periodic “top-off” charge windows by temporarily opening the battery breaker and closing a grid or generator breaker to maintain cell balance and battery longevity.

Battery SoC moderate (e.g., ˜40-60%). In response to determining that the SoC is near a nominal mid-range, the site controller 122 can implement a load-share setpoint by maintaining the battery breaker closed while closing a second source breaker (e.g., generator or grid) and setting a target real-power split (e.g., 30/70 to 50/50) to reduce cycling depth while meeting demand.

Battery SoC low (e.g., ≤20-30%). In response to determining that the SoC is below a reserve threshold, the site controller 122 may open the battery breaker to preserve reserve capacity and close a generator/grid breaker to carry the load and/or recharge the battery, optionally applying current limits to the charger to comply with feeder constraints or utility demand limits.

Battery State-of-Health (SoH) degraded. In response to determining that a battery source has degraded SoH (e.g., reduced capacity, elevated internal resistance, abnormal temperature rise), the site controller 122 may derate the battery's dispatch by limiting its contribution to a predefined maximum kW/kVA, increase the SoC reserve threshold, and/or short-cycle open/close sequences to shift more load to a healthier source. If predicted thermal limits are exceeded, the site controller 122 can open the battery breaker and flag the asset for maintenance.

Generator warm-up/cool-down. In response to a start command or load request, the site controller 122 may keep the generator breaker open while monitoring speed, voltage, and frequency until synchronization tolerances (e.g., voltage magnitude, frequency, and phase angle) are met, then close the breaker across a controlled ramp to avoid transients. Prior to shutdown, the site controller 122 can open the generator breaker and maintain a cool-down run to recommended oil/temperature levels before issuing a stop.

Inverter overload/thermal limit. In response to detecting an inverter source approaching current, temperature, or derating thresholds, the site controller 122 may close a supplemental source breaker and proportionally shed battery/inverter contribution (e.g., by adjusting power setpoints or opening the inverter breaker upon alarm) to prevent trip, while maintaining continuity of service.

Fault isolation. In response to detecting downstream fault current or breaker trip indications, the site controller 122 may open the affected source breaker(s) to isolate the faulted segment and close an alternate source path, where available, to backfeed loads. The site controller 122 may also enforce non-reclose intervals and staged re-energization to verify fault clearance.

Grid outage/islanding. In response to detecting grid undervoltage, underfrequency, or loss of phase, the site controller 122 may open the grid-tie breaker to prevent unintentional backfeed and close one or more local source breakers (e.g., generator and/or battery) in a prescribed black-start sequence. Upon grid restoration, the site controller 122 may resynchronize within defined tolerances and re-close the grid breaker before ramping down local sources.

Demand charge/import limit compliance. In response to determining that grid import is approaching a contractual limit or demand-charge threshold, the site controller 122 may close the battery breaker and dispatch discharge to cap import, or close a generator breaker to supplement peak load, while maintaining the grid breaker closed for stability.

Power quality/frequency support. In response to frequency droop or voltage sag events, the site controller 122 may temporarily increase real-power dispatch from fast-responding sources (battery/inverter) by keeping their breakers closed and commanding higher setpoints, while optionally opening or limiting slower sources to avoid instability, then restoring nominal shares once parameters recover.

Thermal/environmental constraints. In response to elevated ambient temperature or restricted ventilation, the site controller 122 may reduce dispatch from heat-sensitive assets and reassign load to cooler assets by corresponding breaker operations, or open non-critical source breakers to maintain safe operating margins.

Maintenance and test modes. In response to a scheduled maintenance window, the site controller 122 may open the breaker associated with the asset under service and close alternate source breakers to maintain continuity, optionally scheduling an unloaded test close for generators/inverters and recording telemetry to update SoH estimates.

It should be understood that the foregoing sequences are illustrative examples of logic executed during step 614, and that the specific open/close commands, timing, and load-share setpoints can be adaptively varied based on additional constraints such as feeder ampacity, harmonic distortion limits, reactive power requirements, and asset-specific control policies, without departing from the scope of the present disclosure.

Referring to FIG. 6C, the method 600 may include receiving, at the site controller 122, at least one of: (i) a forecasted load profile, (ii) a utility-provided operating constraint, or (iii) a learned optimization policy trained over historical asset performance (step 616). The forecasted load profile or operating constraint may be communicated from a utility or customer system over the network 106, while the learned optimization policy may be derived from orchestration algorithms running on the site controller 122. Based on the received information, the site controller 122 may schedule operation of the first power source 108 and the second power source 110 (step 618). Scheduling may include determining whether to dispatch one or both sources, adjusting inverter or generator setpoints, or prioritizing battery discharging during peak demand periods.

In this way, the method 600 provides for coordinated operation of multiple power sources through the electrical combiner system 112. The site controller 122 supervises the programmable controllers 116, 120 of the breakers, synchronizes electrical parameters, and implements orchestration algorithms that account for asset health, load demand, and external constraints. The method enables flexible operation in islanded, grid-connected, or peak-shaving modes, and may further employ predictive or machine learning techniques to improve efficiency, reliability, and responsiveness of the mobile grid system 100.

In various aspects, a method of power delivery is also provided. The method may begin with generating, by a power generation system (e.g., power generation system 102 of FIG. 1), electrical power. The power generation system 102 can include any suitable facility, such as a coal-fired or gas-fired plant, a solar farm, a wind farm, a nuclear plant, or a hydroelectric facility. At certain times, the power generation system 102 may operate with excess capacity, such that surplus electrical power can be directed to a mobile power system 104 rather than curtailed.

The method further includes connecting the mobile power system 104 in electrical communication with the power generation system 102, and transferring electrical power from the power generation system 102 to the mobile power system 104. In various aspects, the mobile power system 104 is a trailer-mounted or skid-mounted energy storage system, such as a battery energy storage system (BESS), that can be charged directly from the power generation system. Once charged, the mobile power system 104 may be transported to a power delivery site 126, where an electrical combiner system 112 is located. At the power delivery site, the method includes connecting the mobile power system 104 in electrical communication with the electrical combiner system 112, and transferring electrical power from the mobile power system 104 to the electrical combiner system 112. The electrical combiner system can then operate as described previously.

By incorporating a transportable mobile power system 104 into the delivery pathway, the method allows energy to be generated at one site, stored and transported, and then delivered at a separate power delivery site 126 in coordination with locally available sources. The site controller 122 ensures that incoming power from the mobile power system 104 is safely synchronized with power from other sources (e.g., a generator, inverter, or grid interconnection) before being supplied to local loads. This architecture enables flexible deployment of stored energy, improves utilization of surplus generation capacity, and enhances resiliency at distributed power delivery sites.

In the present disclosure, the following terminology will be used: The singular forms “a,” “an,” and “the” include plural referents unless the context clearly dictates otherwise. Thus, for example, reference to an item includes reference to one or more items. The term “ones” refers to one, two, or more, and generally applies to the selection of some or all of a quantity. The term “plurality” refers to two or more of an item. The term “about” means quantities, dimensions, sizes, formulations, parameters, shapes, and other characteristics need not be exact, but may be approximated and/or larger or smaller, as desired, reflecting acceptable tolerances, conversion factors, rounding off, measurement error and the like and other factors known to those of skill in the art. The term “substantially” means that the recited characteristic, parameter, or value need not be achieved exactly, but that deviations or variations, including, for example, tolerances, measurement error, measurement accuracy limitations and other factors known to those of skill in the art, may occur in amounts that do not preclude the effect the characteristic was intended to provide. Numerical data may be expressed or presented herein in a range format. It is to be understood that such a range format is used merely for convenience and brevity and thus should be interpreted flexibly to include not only the numerical values explicitly recited as the limits of the range, but also interpreted to include all of the individual numerical values or sub-ranges encompassed within that range as if each numerical value and sub-range is explicitly recited. As an illustration, a numerical range of “about 1 to 5” should be interpreted to include not only the explicitly recited values of about 1 to about 5, but also include individual values and sub-ranges within the indicated range. Thus, included in the numerical range are individual values such as 2, 3 and 4 and sub-ranges such as 1-3, 2-4 and 3-5, etc. The same principle applies to ranges reciting only one numerical value (e.g., “greater than about 1”) and should apply regardless of the breadth of the range or the characteristics being described. A plurality of items may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary. Furthermore, where the terms “and” and “or” are used in conjunction with a list of items, they are to be interpreted broadly, in that any one or more of the listed items may be used alone or in combination with other listed items. The term “alternatively” refers to selection of one of two or more alternatives, and is not intended to limit the selection to only those listed alternatives or to only one of the listed alternatives at a time, unless the context clearly indicates otherwise.

It should be appreciated that the particular implementations shown and described herein are illustrative of the example embodiments and their best mode and are not intended to otherwise limit the scope of the present disclosure in any way. Furthermore, the connecting lines shown in the various figures contained herein are intended to represent exemplary functional relationships and/or physical couplings between the various elements. It should be noted that many alternative or additional functional relationships or physical connections may be present in a practical device.

As one skilled in the art will appreciate, the mechanism of the present disclosure may be suitably configured in any of several ways. It should be understood that the mechanism described herein with reference to the figures is but one exemplary embodiment of the disclosure and is not intended to limit the scope of the disclosure as described above.

It should be understood, however, that the detailed description and specific examples, while indicating exemplary embodiments of the present disclosure, are given for purposes of illustration only and not of limitation. Many changes and modifications within the scope of the instant disclosure may be made without departing from the spirit thereof, and the disclosure includes all such modifications. The corresponding structures, materials, acts, and equivalents of all elements in the claims below are intended to include any structure, material, or acts for performing the functions in combination with other claimed elements as specifically claimed. The scope of the disclosure should be determined by the appended claims and their legal equivalents, rather than by the examples given above. For example, the operations recited in any method claims may be executed in any order and are not limited to the order presented in the claims. Moreover, no element is essential to the practice of the disclosure unless specifically described herein as “critical” or “essential.”

Furthermore, no element, component, or method step in the present disclosure is intended to be dedicated to the public regardless of whether the element, component, or method step is explicitly recited in the claims. No claim element herein is intended to invoke 35 U.S.C. 112(f), unless the element is expressly recited using the phrase “means for.” As used herein, the terms “comprises”, “comprising”, or any other variation thereof, are intended to cover a non-exclusive inclusion, such that a process, method, article, or apparatus that comprises a list of elements does not include only those elements but may include other elements not expressly listed or inherent to such process, method, article, or apparatus.

What is claimed:

1. An electrical combiner system, comprising:
a first breaker in electrical communication with a first power source, wherein the first breaker comprises a first programmable controller;
a second breaker in electrical communication with a second power source, wherein the second breaker comprises a second programmable controller;
a site controller in electronic communication with the first breaker and the second breaker, wherein the site controller is configured to synchronize a voltage of the first power source and a voltage of the second power source, including at least one of voltage magnitude, frequency, and phase angle, to output a combined voltage; and
a network device in communication with a network, wherein the network device is in electronic communication with at least one of the first programmable controller and the second programmable controller.

2. The electrical combiner system of claim 1, wherein the first power source is a generator.

3. The electrical combiner system of claim 2, wherein the second power source is a battery.

4. The electrical combiner system of claim 1, wherein the first breaker and the second breaker are motor-operated.

5. The electrical combiner system of claim 4, wherein:
the first programmable controller is configured to control a state of the second breaker between a first open position and a first closed position; and
the second programmable controller is configured to control a state of the second breaker between a second open position and a second closed position;
wherein the first programmable controller and the second programmable controller are in electronic communication with the site controller.

6. The electrical combiner system of claim 1, wherein the site controller is configured to selectively operate the first breaker and the second breaker to provide at least one of: (i) an islanded mode in which a power distribution system is disconnected from a utility grid; and (ii) a grid-connected mode in which at least one of the first power source and the second power source is synchronized with the utility grid.

7. The electrical combiner system of claim 1, wherein the network device is configured to communicate with a remote control application to receive commands for breaker operation and transmit telemetry data from at least one of the first programmable controller and the second programmable controller.

8. The electrical combiner system of claim 1, further comprising a housing defining a volume, and wherein at least one of the first breaker, the second breaker, the site controller, and the network device is disposed in the housing.

9. The electrical combiner system of claim 8, wherein the housing comprises a plurality of modular enclosures, each modular enclosure including a respective motor-operated breaker and being configured to couple to the site controller for scalable deployment of additional power sources.

10. The electrical combiner system of claim 1, further comprising a plurality of edge compute devices, each edge compute device operatively coupled to a respective power asset and configured to translate an industrial protocol into a network-accessible endpoint for communication with the site controller.

11. The electrical combiner system of claim 10, wherein each network-accessible endpoint exposes a plurality of telemetry channels and writable command channels, and wherein the site controller is configured to discover each network-accessible endpoint, ingest metadata describing the telemetry channels, and enable monitoring and control of the respective power asset.

12. The electrical combiner system of claim 1, wherein the site controller is configured to inject telemetry obtained from the first programmable controller, the second programmable controller, and one or more edge compute devices into a telemetry database hosted in a virtual private cloud.

13. The electrical combiner system of claim 12, wherein the telemetry database is queryable and is further configured to store issued control commands as writable telemetry channels.

14. The electrical combiner system of claim 1, wherein the electrical combiner system further comprises a plurality of quick-disconnect electrical connectors, each quick-disconnect electrical connector configured for tool-less connection and disconnection of a power source or load cable.

15. A method of operating an electrical combiner system, comprising:
receiving, at a first breaker, electrical power from a first power source;
receiving, at a second breaker, electrical power from a second power source;
controlling a first programmable controller of the first breaker and a second programmable controller of the second breaker;
synchronizing, by a site controller in electronic communication with the first programmable controller and the second programmable controller, at least one of a voltage magnitude, frequency, and phase angle of the first power source and the second power source; and
outputting, from the electrical combiner system, a combined voltage from the first power source and the second power source.

16. The method of claim 15, further comprising transmitting, via a network device, a remote command from a control application to the site controller, wherein the site controller relays the remote command to at least one of the first programmable controller and the second programmable controller to selectively open or close the respective first breaker or second breaker.

17. The method of claim 15, wherein synchronizing further comprises:
monitoring, at the site controller, a state of health of at least one battery, an operating status of at least one generator or inverter, and real-time load demand; and
adjusting breaker operation based on at least one of the state of health of at least one battery, the operating status of at least one generator or inverter, and the real-time load demand.

18. The method of claim 15, further comprising operating the electrical combiner system in at least one of:
an islanded mode in which the electrical combiner system supplies power to a power distribution system without a utility grid connection;
a grid-connected mode in which the electrical combiner system synchronizes the first power source or the second power source with a utility grid; or
a peak-shaving mode in which a battery discharges to reduce utility grid draw during high demand periods.

19. The method of claim 15, further comprising executing, by the site controller, an orchestration algorithm that schedules operation of the first power source and the second power source based on at least one of: (i) a forecasted load profile, (ii) a utility-provided operating constraint, or (iii) a learned optimization policy trained over historical asset performance.

20. A method of power delivery comprising:
generating, by a power generation system, electrical power;
connecting a mobile power system in electrical communication to the power generation system;
transferring, by the power generation system, the electrical power to the mobile power system;
transporting the mobile power system to a power delivery site, wherein the power delivery site comprises an electrical combiner system;
connecting the mobile power system in electrical communication to the electrical combiner system; and
transferring, by the mobile power system, the electrical power to the electrical combiner system, wherein the electrical combiner system comprises:
a first breaker in electrical communication with a first power source, wherein the first breaker comprises a first programmable controller;
a second breaker in electrical communication with a second power source, wherein the second breaker comprises a second programmable controller;
a site controller in electronic communication with the first breaker and the second breaker, wherein the site controller is configured to synchronize a voltage of the first power source and a voltage of the second power source, including at least one of voltage magnitude, frequency, and phase angle, to output a combined voltage; and
a network device in communication with a network, wherein the network device is in electronic communication with at least one of the first programmable controller and the second programmable controller.
